(19) United States
(12) Patent Application Publication
(10) Pub. No.: US 2015/0127754 A1
(43) Pub. Date: May 7, 2015

(54) SYSTEMS AND METHODS FOR COLLECTING MEDIA CONTENT

(71) Applicant: Photobucket Corporation, Denver, CO (US)

(72) Inventors: Michael P. Clark, Highlands Ranch, CO (US); Katharine A. Hare, Phoenix, AZ (US); Thomas A. Munro, Castle Rock, CO (US); Jeffrey Selk, Greenwood Village, CO (US)

(21) Appl. No.: 14/532,603

(22) Filed: Nov. 4, 2014

Related U.S. Application Data
(60) Provisional application No. 61/899,853, filed on Nov. 4, 2013.

(51) Int. Cl. H04L 12/58; H04W 4/14

(52) U.S. Cl. CPC H04L 51/10; H04W 4/14
USPC 709/206

(57) ABSTRACT

A system and method are provided for collecting photographs, drawings, videos and other media elements from one or more sources. A user on one site can create an album associated with one or more identifiers and the site can search for and retrieve media elements associated with the identifiers on other sites or in other locations. The collection of media elements may then be stored or posted in the album and access given to others for viewing the collection.

### RELATED APPLICATIONS

This application claims priority under 35 U.S.C. §119(e) to U.S. Provisional Patent Application No. 61/899,853 by Michael P. Clark et al. and titled “SYSTEMS AND METHODS FOR COLLECTING MEDIA CONTENT” filed Nov. 4, 2013, which is incorporated herein by reference in its entirety.

### TECHNICAL FIELD

Aspects of the present disclosure relate generally to the field of arranging and viewing images and other media. More particularly, aspects of the present disclosure relate to collecting media elements from one or more online or social media sites or other locations. More particularly still, aspects of the present disclosure relate to automatically and/or manually collecting media related by association of a hashtag or identifier with various media elements. Still further aspects of the present disclosure relate to sharing a collection of media elements by providing access to the collection to others.

### BACKGROUND OF RELATED ART

Various web-based photo sharing systems allow users to upload, share and print photographs or other pictures over the Internet. Such systems may provide users with various options for organizing the uploaded images. A common technique is to allow the creation of individual albums or folders, which may in turn also have other sub-albums or sub-folders. A user may choose what folders or albums to create, with each typically having a theme so as to allow related images to be found in the same album or folder.

Users may choose any number of different types of themes for their respective folders or albums. Example themes may be based on time periods (e.g., a year, month or day), events (e.g., a vacation, a holiday, a graduation, etc.), a person within a folder (e.g., a son, daughter, parent, etc.), another type of collection, or any combination of the foregoing. For instance, an album based on a wedding event may have the name “Amy's Wedding”. Images stored in such a folder may be those taken of the wedding celebration or the couple. A wedding may also include other events other than simply the activities on the wedding day. Accordingly, such an album may have various sub-albums. For instance, sub-albums may have titles such as: “Engagement,” “Dress Rehearsal,” Bachelorette Party,” or “Wedding Day.” The various photographs or other images related to the various events related to the wedding may then be stored in the main album, or in a corresponding sub-album.

Users may also “tag” images with tags, labels, or other identifiers, such as hashtags, to indicate a subject or other property of the image, or simply to indicate a relation to other images or social media posts with the same tag or other identifier. Within a specific site, users may be able to select a tag or other identifier and view all images associated with it. Users will not see, however, images associated with this tag that have been posted on other sites, services, or locations, e.g., on a social media site such as through a post or message on FACEBOOK®, TWITTER®, INSTAGRAM®, TUMBLR®, etc. Consequently, what is needed are improved systems and methods for collecting and sharing images or other media from various locations.

### SUMMARY

In accordance with aspects of the present disclosure, embodiments of methods, systems, software, computer-program products, and the like are described or would be understood and which relate to collecting, sharing and organizing of photographs or other media elements.

In one embodiment, a system for presenting a plurality of media files identified as related by a plurality of users is disclosed. The system can comprise a program configured to review a first set of data received from a first media service and a second set of data received from a second media service. The program can be configured to retrieve one or more media files identified by a unique identifier located within the first set of data and to retrieve one or more media files identified by the unique identifier located within the second set of data. The system can further comprise a service account associated with a storage medium for storing and presenting the one or more media files identified by the unique identifier.

In a further aspect, in some embodiments the system can further comprise an email account configured to receive one or more messages containing the unique identifier and send one or more email media files identified by the one or more messages to the service account for storage on the storage medium.

In other embodiments, the system can further comprise a short messaging service (SMS) code provided to the plurality of users to allow the plurality of users to send an SMS message comprising the unique identifier to the service account for storing one or more SMS media files in the storage medium.

In another embodiment, a system for gathering media messages is disclosed. The system can comprise a computer-readable storage medium associated with a service account. The system further comprises a program configured to identify a plurality of media messages addressed to the service account and to retrieve the plurality of media messages for storage in the computer-readable storage medium.

In another embodiment, a method for collecting media files from a plurality of sources is disclosed. The method comprises assigning a unique identifier to a primary user that controls an account with a primary media service. The method further comprises receiving a plurality of media files from a secondary source that provides a secondary media service. In another step, a secondary set of one or more related media files associated with the unique identifier by a secondary user of the secondary media service is identified. The method further comprises receiving a plurality of media files from a tertiary source that provides a tertiary media service. Additionally, a tertiary set of one or more related media files associated with the unique identifier by a user of the tertiary media service is identified. The method further comprises storing the secondary set of one or more related media files and the tertiary set of one or more related media files in a section of the account identified by the unique identifier and allowing the primary user of the primary media service to provide one or more of the secondary user and the tertiary user access to the section of the account identified by the unique identifier.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a schematic illustration of an example communication system which may be used for collecting, storing, arranging, or editing media elements according to an embodiment of the present disclosure;

FIG. 2 is a schematic illustration of an example computing system which may be used in the communication system of FIG. 1, the example computing system being suitable for use as a client computing system for receiving user input or creating media, or as a server component which communicates with client systems, according to an embodiment of the present disclosure;

FIG. 3 is a schematic illustration of an example system for collecting media elements for posting on a central site, according to an embodiment of the present disclosure;

FIG. 4 illustrates an example method for collecting media elements, according to an embodiment of the present disclosure.

### DETAILED DESCRIPTION

Systems, methods, devices, software and computer-program products according to the present disclosure may be configured for use in accessing, storing, arranging and sharing photographs, videos, drawings, text, or other media elements. Without limiting the scope of the present disclosure, media data processed using embodiments of the present disclosure may include still or video image data. Image data may be representative of digital photographs or videos taken using a digital camera, or which is scanned or otherwise converted to a digital form. Similarly, image data may include drawings, paintings, schematics, documents, or the like which are created in, or converted to, a digital format.

Some media elements, regardless of the particular type of media, may be related. Such elements may be related in date/time, location, event, subject matter, or another manner, or in some combination thereof. Some media elements may be related by the actions of one or more users in tagging, labeling, or otherwise designating or identifying media elements as related (hereinafter, “tagging”). Tagging may be accomplished in any manner of ways, by, for example, applying a hashtag (e.g., the “#” symbol followed by one or more text elements) to one or more media elements by inputting a word, key, symbol, etc. in a metadata or other field associated with a media element. Two or more media elements can be considered related by simply having the same or similar tag or identifier applied to them, whether or not they are also related in terms of content, date/time, etc.

A web-based social media or other site can allow users to use hashtags or other tags or labels to facilitate grouping related media elements on that site. A smartphone or other device can also be used to post to more than one site at once, e.g., by prompting a user or allowing for a default setting to post a message posted to Instagram® on Facebook® also. A company or individual may also, for example, search multiple web-based social media or other sites potentially containing hashtags or any association of a text field with a media element to gather or collect media elements related by the hashtag or other label. Such a process can be performed manually or automatically using, for example, an application programming interface (API) or other software component to search (including to instruct a computer or other software to search) for hashtags or other labels across more than one site.

In some embodiments, importing media elements with the same hashtag from one or more sites allows for the collection, storage, or arrangement of related media elements for access by selected users. A central site may allow a user to establish a unique key, e.g., register a hashtag or other label and preclude registration of the same hashtag or label by another user. The central site can then facilitate collection of media elements associated with the unique key from its own site or from one or more other sites or storage locations accessible from one or more networks. In other embodiments, the central site can allow more than one user to register the same hashtag or other identifier.

Certain aspects of the systems described in this disclosure may be used for implementing an online service for creating, sharing, editing, and collecting or gathering groups of media elements (e.g., images), as described in more detail herein. As such, the system architecture for providing such a system will be described, as well as a detailed description of a system and methods for collecting or gathering media elements. From time to time, the term “image” may be used in reference to the system for collecting media elements. It should be appreciated, however, that such term is for convenience only, and that any so-called “image” may include a variety of types of images (e.g., photographs, videos, drawings, etc.). Further, the term “media element” may also be used herein. The term “media element” may include images of any type, as well as any other type of media, including, but not limited to, text, advertisements, presentations, or other types of media, or any combination of the foregoing.

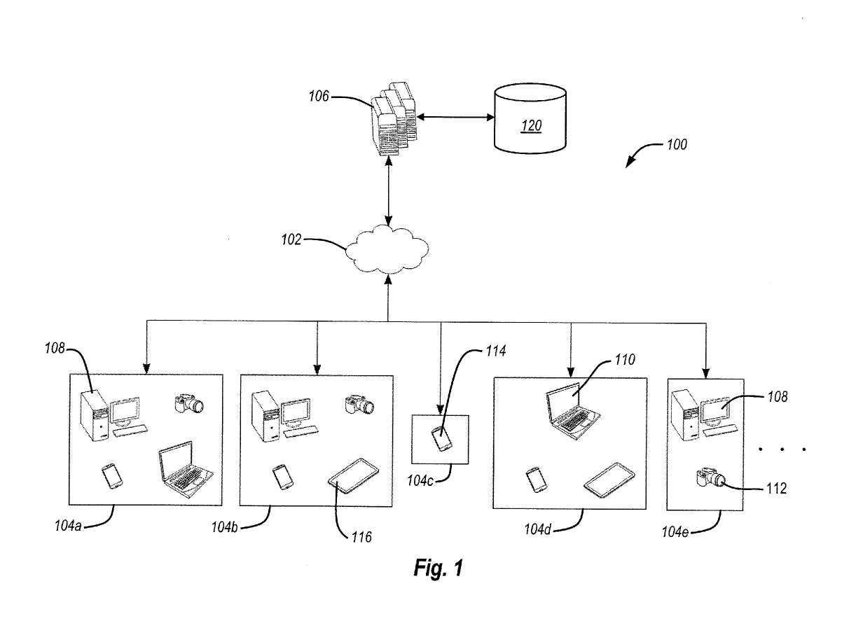

Turning now to FIG. 1, an example computing system 100 is shown and is representative of systems that may be used in connection with embodiments of the present disclosure for collecting, accessing, storing, arranging, and editing images. The illustrated system 100 is depicted as a distributed system.

The illustrated system 100 may operate using a network 102 facilitating communication between one or more end users 104a-104e and a server component 106. The end users 104a-104e may represent persons, businesses, or other entities that may have access to image data or other media elements or desire to gather media elements from other sources, and which may want to share or publish the elements, or arrange the elements into a story progression as described in U.S. patent application Ser. No. 13/958,519, filed on Aug. 2, 2013 and titled System for Creating Stories Using Images, and Methods and Interfaces Associated Therewith, which application is expressly incorporated herein by this reference in its entirety. The system may also have structures or capabilities described in the following applications, each of which is hereby incorporated in its entirety by this reference: U.S. Pat. No. 7,698,392 titled METHOD AND SYSTEM FOR ESTABLISHING A USER-FRIENDLY DATA TRANSFER SERVICE APPLICATION EXECUTING WITHIN A HETEROGENOUS SERVICE APPLICATION EXECUTION ENVIRONMENT; U.S. Pat. No. 8,015,253 titled SYSTEM AND METHOD FOR CONTROLLING INTER-DEVICE MEDIA EXCHANGES, U.S. Pat. No. 7,610,056 titled METHOD AND SYSTEM FOR PHONE-NUMBER DISCOVERY AND PHONE-NUMBER AUTHENTICATION FOR MOBILE COMMUNICATION DEVICES; U.S. patent application Ser. No. 11/877,845 titled SYSTEM AND METHOD FOR AUTOMATIC TRANSFER OF DATA FROM ONE DEVICE TO ANOTHER; U.S. patent application Ser. No. 12/569,313 titled SYSTEM AND METHOD FOR ALLOWING A USER TO OPT FOR AUTOMATIC OR SELECTIVELY SENDING OF MEDIA.

The end-users 104a-104e may use any of various different types of end-user computing devices to interact with the server component 106. By way of example, the end-users 104a-104b may use traditional computing devices such as a desktop computer 108 or a laptop computer 110. As technology has advanced in recent years, other devices are also becoming increasingly powerful and may provide expanded computing capabilities. Accordingly, other computing devices that may be used by an end-user may include cameras 112, portable electronic devices 114 (e.g., mobile phones including so-called “smart phones”, personal digital assistants, personal media players, GPS units, watches, etc.), and tablet computing devices 116.

It should be appreciated in view of the disclosure herein that the end-user devices 108-116 are provided merely to illustrate that users may interact with a communication system using any number of different types of devices, and they are not intended to provide an exhaustive list of devices that may be used by an end-user 104a-104e. Indeed, examples of other suitable end-user devices may include land-line phones, netbooks, e-readers, two-way radio devices, other devices capable of communicating data over the network 102 or with another end-user device 108-116, or any combination of the foregoing.

In some embodiments, end-user devices 108-116 may communicate with the server component 106, or with other end-user devices 108-116 through the network 102. In other embodiments, out-of-band communications (not shown) may allow communications to bypass the network 102. In still other embodiments, an end-user device may not be capable of communicating with the network 102 or the server component 106. In such an embodiment, the end-user device may, however, be capable of communicating with another device (e.g., another end-user device of a particular end-user 104a-104e), which can then communicate with the network 102 and/or server component 106. For instance, the end-user 104e is illustrated as having access to a desktop computer 108 and a camera 112. While the camera 112 may include a communication interface capable of communicating directly with the network 102, the camera 112 may in other embodiments lack such a communication interface. Instead, a cable, memory card, or other communication interface may be provided to interface with the desktop computing device 108 which in turn may have a suitable communication interface for communicating with the server component 106, either directly or via the network 102.

An aspect of the various end-user computing devices 108-116 is that each may have the capability to store and/or generate data corresponding to media elements, as well as the ability to provide the data to one or more other components of the system 100. A camera 112, for instance, may be able to take still or video images. Such images may be stored on the camera's internal or removable storage media. Using the removable media, or a wired or wireless communication connection, or a combination thereof, the camera 112 can provide another computing device (e.g., another end-user device or the server component 106) with access to the stored images.

Of course, images or other media elements may be created or accessed by other end-user devices in similar manners. A desktop computer 108, laptop computer 110, portable electronic device 114, or tablet computing device 116 may access images stored on a camera (e.g., camera 112). Alternatively, such devices may have their own cameras so as to be able to generate images on their own, or have access to other peripheral devices (e.g., scanners) that can provide image data. Moreover, such devices are not limited to photographs or videos. For instance, an end-user device 108-116 may have software allowing a user to create a drawing, sketch, or other image, or to even edit an existing photograph or drawing. End-user devices 108-116 may also have the ability to create other media elements, including multimedia presentations, advertisements, text, sound effects, or other audio data, or other media, including animated images, or some combination of the foregoing.

In accordance with one aspect of the present disclosure, end-users 104a-104e provide data corresponding to one or more media elements to the server component 106, and the server component 106 may facilitate storage and/or sharing of the data. The server component 106 may comprise a single device or multiple devices to provide such functions. In FIG. 1, for instance, the server component 106 may include multiple servers and/or access to a data store 120. The data store 120 may be used to store raw data of the various images, or other media provided by an end-user 104a-104e. Information on the data store 120 may be accessed by the server component 106. In the same or other embodiments, the data store 120 may store processed data, including information related to the arrangement of media. The server component 106 may represent multiple servers or other computing elements either located together or distributed in a manner that facilitates operation of one or more aspects of the system 100. Additionally, while the optional storage 120 is shown as being separate from the server component 106 and the end-user or client devices 108-116, in other embodiments the storage 120 may be wholly or partially included within any other device, system or component.

In at least one embodiment, the network 102 may be capable of carrying electronic communications. The Internet, local area networks, wide area networks, virtual private networks (“VPN”), telephone networks, other communication networks or channels, or any combination of the forgoing may thus be represented by the network 102. Communication may be provided in any number of manners. For instance, messages that are exchanged may make use of Internet Protocol (“IP”) datagrams, Transmission Control Protocols (“TCP”), Hypertext Transfer Protocol (“HTTP”), Simple Mail Transfer Protocol (“SMTP”), Voice-Over-IP (“VOIP), land-line or plain old telephone system (“POTS”) services, or other communication protocols or systems, or any combination of the foregoing. Thus, the network 102, the end-user devices 108-116, the server component 106, and the data store 120, may each operate in a number of different manners, any or all of which may have communication capabilities to allow access and/or processing of image data consistent with the disclosure herein.

The system 100 is illustrative, but not limiting, of a media processing system that may be used to access any of a number of different types of media, to arrange media elements in a story progression, to share media elements or story progressions, to collaborate with others in creating story progressions, or for other purposes, or any combination of the foregoing. In one example embodiment, the system 100 may include the use of the end-user devices 108-116 to provide media elements to the server component 106. The server component 106 may include software, firmware, processing capabilities, or other features that allow the server component 106 to access media elements from various sources, including other sites accessible via one or more networks. In other embodiments, the end-user devices 108-116 may include the capabilities to access media elements from other sites accessible via one or more networks to publish them directly to the system 100. In such an embodiment, the server component 106 may be used to facilitate storage of the media elements, sharing of the media elements or story progression with others for either viewing or editing, access of template or intelligence information for arranging media elements, or other capabilities. Of course, a combination of the foregoing may also be provided so as to allow the end-user devices 108-116 and the server component 106 to each include some functions for cooperating to collect media elements from various sources and process or arrange such media elements. System 100 can include sites available online such as www.photobucket.com.

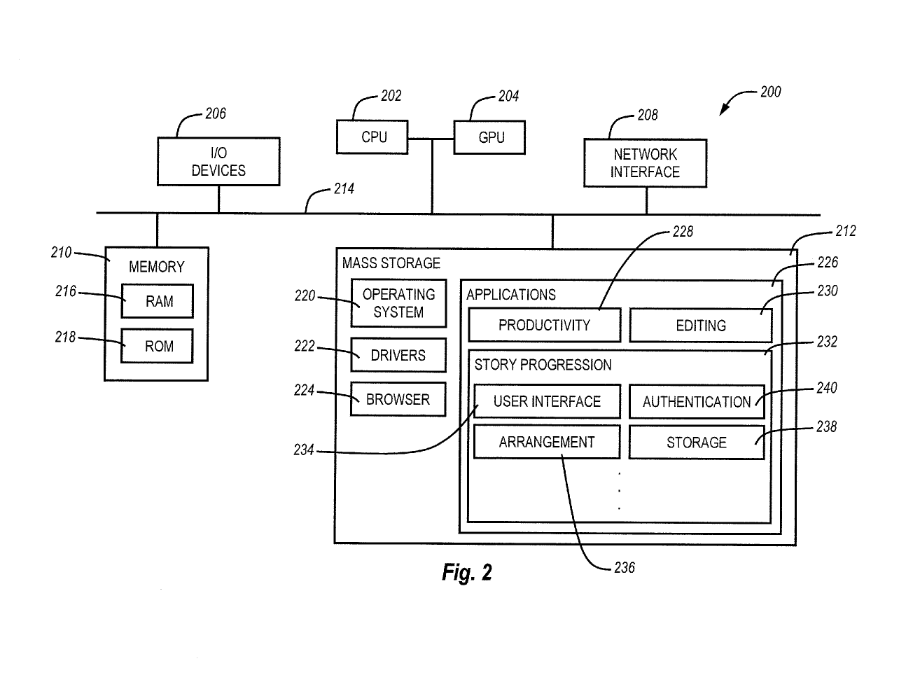

Turning now to FIG. 2, an example of a computing system 200 is illustrated and described in additional detail. The computing system 200 may generally represent an example of one or more of the devices, systems or components that may be used in the communication system 100 of FIG. 1. Thus, in some embodiments the computing system 200 may represent the server component 106, while in other embodiments the computing system 200 may represent an end-user device 108-116. In still other embodiments, the computing system 200 may be part of the network 102, or otherwise operate within the system 100 or as part of a third party service or application, or some combination of any of the above.

In FIG. 2, the computing system 200 includes multiple components that may interact together over one or more communication channels. In this embodiment, for instance, the system 200 optionally includes multiple processing units. More particularly, the illustrated processing units include a central processing unit (CPU) 202 and a graphics processing unit (GPU) 204. The CPU 202 may generally be a multi-purpose processor for use in carrying out instructions of computer programs of the system 200, including basic arithmetical, logical, input/output (I/O) operations, or the like. In contrast, the GPU 204 may be primarily dedicated to processing of visual information. In one example embodiment, the GPU 204 may be dedicated primarily to building images intended to be output to one or more display devices that are part of, or otherwise connected to, the computing system 200. In other embodiments, a single processor or multiple different types of processors may be used other than, or in addition to, those illustrated in FIG. 2.

The CPU 202, GPU 204 or other processing components may interact or communicate with input/output (I/O) devices 206, a network interface 208, memory 210 and/or a mass storage device 212. One manner in which communication may occur is using a communication bus 214, although multiple communication busses or other communication channels, or any number of other types of component may be used. The CPU 202 and/or GPU 204 may generally include one or more processing components capable of executing computer-executable instructions received by, accessible to, or stored by the system 200. For instance, the CPU 202 or GPU 204 may communicate with the input/output devices 206 using the communication bus 214. The input/output devices 206 may include ports, keyboards, cameras, scanners, printers, display devices, touch screens, a mouse, microphones, speakers, sensors, other components, or any combination of the foregoing, at least some of which may provide input for processing by the CPU 202 or GPU 204, or be used to receive information output from the CPU 202 or GPU 204. In at least some embodiments, input devices of the I/O devices 206 may provide information in response to user input.

The network interface 208 may receive communications via a network (e.g., network 102 of FIG. 1). Received data may be transmitted over the bus 214 and processed in whole or in part by the CPU 202 or GPU 204. Alternatively, data processed by the CPU 202 or GPU 204 may be transmitted over the bus 214 to the network interface 208 for communication to another device or component over a network or other communication channel.

The system 200 may also include memory 210 and mass storage 212. In general, the memory 210 may include both persistent and non-persistent storage, and in the illustrated embodiment the memory 210 is shown as including random access memory 216 and read only memory 218. Other types of memory or storage may also be included in memory 210.

The mass storage 212 may generally be comprised of persistent storage in a number of different forms. Such forms may include a hard drive, flash-based storage, optical storage devices, magnetic storage devices, or other forms which are either permanently or removably coupled to the system 200, or in any combination of the foregoing. In some embodiments, an operating system 220 defining the general operating functions of the computing system 200, and which may be executed by the CPU 202, may be stored in the mass storage 212. Other example components stored in the mass storage 212 may include drivers 226, a browser 224 and application programs 226.

The term “drivers” is intended to broadly represent any number of programs, code, or other modules including Kernel extensions, extensions, libraries, or sockets, and generally represent programs or instructions that allow the computing system 200 to communicate with other components within or peripheral to the computing system 200. For instance, in an embodiment where the I/O devices 206 include a camera, the drivers 226 may store or access communication instructions indicating a manner in which data can be formatted to allow communication between the camera and the CPU 202. The browser 224 may be a program generally capable of interacting with the CPU 202 and/or GPU 204, as well as the network interface 208 to browse, view or interact with programs or applications on the computing system 200, or to access resources available from a remote source. Such a remote source may optionally be available through a network or other communication channel. Thus, when the computing system 200 is an end-user device, the browser 224 may communicate with a remote source such as a server component (e.g., server component 106 of FIG. 1). In contrast, when the computing system 200 is part of a server system, the browser 224 may interact with a remote source such as an end-user device (e.g., devices 108-116 of FIG. 1). A browser 224 may generally operate by receiving and interpreting pages of information, often with such pages including mark-up and/or scripting language code. In contrast, executable code instructions may generally be executed by the CPU 202 or GPU 204, and may be in a binary or other similar format understood primarily by processor components.

The application programs 226 may include other programs or applications that may be used in the operation of the computing system 200. Examples of application programs 226 may include productivity applications 228 such as email, calendar, word processing, database management, spreadsheet, desktop publishing, or other types of applications. The application programs 226 may also include editing programs 230. Editing programs 230 may be used for various functions. In one embodiment, an editing program 230 may be used to access, retrieve, or modify photographs, videos, drawings, audio data, advertisements, presentations, or other types of media elements. As will be appreciated by one of skill in the art in view of the disclosure herein, other types of applications 226 may provide other functions or capabilities.

In at least one embodiment, the application programs 226 may include applications or modules capable of being used by the system 200 in connection with creating a story progression using multiple images or other media elements. An example story progression application 232 is shown in FIG. 2. For instance, in one example, various media elements available from one or more sources may be accessible to the story progression application 232. The story progression application 232 may use the media elements to generate a continuous and/or logical flow of media elements to in effect provide a narrative.

The modules 234-240 of story progression application are merely some embodiments, and other modules may of course replace or supplement those illustrated in FIG. 2. For instance, an image creation or editing module may be provided to allow a user to edit images. A style module may be provided to further allow customization of text and fonts, backgrounds, music, media layouts, or other thematic elements. These modules may be used in other applications (not shown) or similar modules may separately exist in other applications (not shown).

The system 200 of FIG. 2 is but one example of a suitable system that may be used as a client or end-user device, a server component, or a system within a communication or other computing network, in accordance with embodiments of the present disclosure. In other embodiments other types of systems, applications, I/O devices, communication components or the like may be included. Additionally, although a story progression application 232 is shown on a single system 200, such an application or other applications may be distributed among multiple devices or may execute using multiple, simultaneous instances of any or all of the modules 234-240.

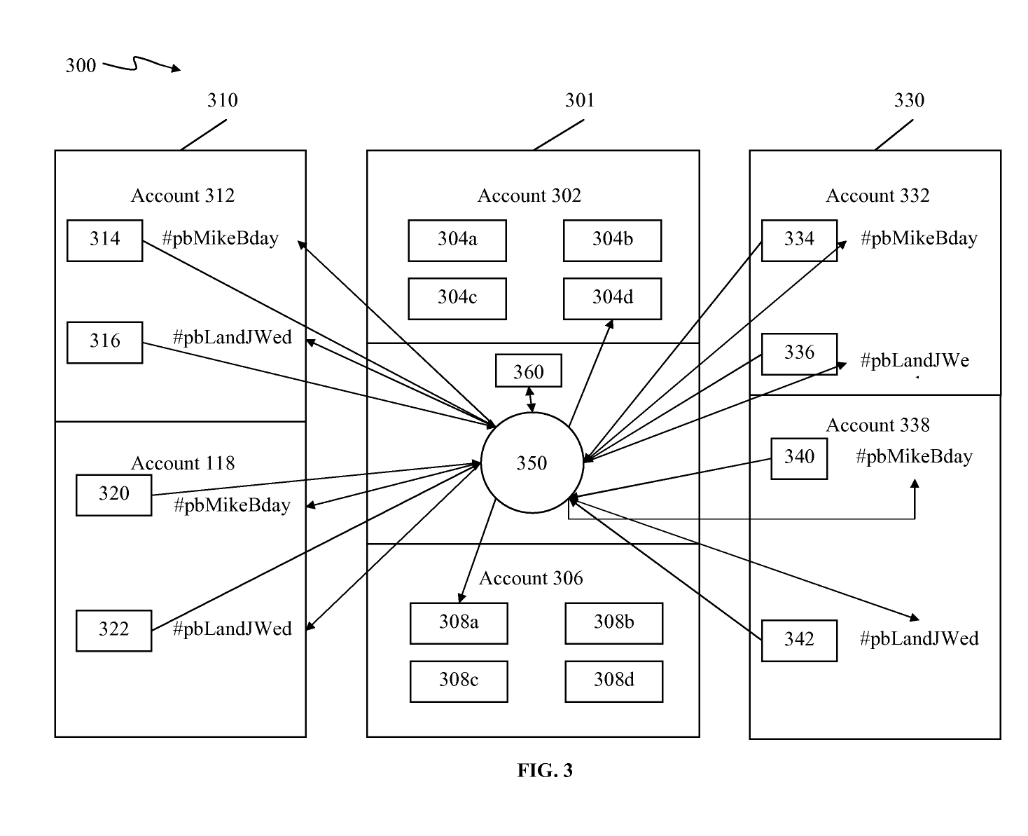

Turning now to FIG. 3, a preferred embodiment of a system 300 for collecting media elements is shown. The system 300 can be structured similar to one or more of system 100 or 200 or have similar capabilities, in addition to those described further herein with respect to FIG. 3. A central site 301, such as photobucket.com, can allow users of the site to establish accounts 302, 306 to store various albums of media elements. Users can be registered users, and the central site 301 can allow registered users to control different levels of access to the various albums stored in each user's account. For example, a user may establish an account 302 and name various albums 304a, 304b, 304c, 304d, and so on within account 302. The user of account 302 may also control access to each album 304a, 304b, and so on individually, in groups and subgroups, or as a whole. Central site 301 can allow the user of account 302 to specify, for example, a password for one or more albums that restricts access to visitors of the site being able to provide the password, or an album can be accessible through a publicly-accessible URL that may or may not be searchable. The same or a different user as that associated with account 302 can control account 306 with its associated albums 308a, 308b, 308c, 308d, and so on.

The user of account 302 can register through the central site 301 a hashtag or label, such as #pbMikeBday, that may or may not relate to a specific event, idea, location, group, etc. The central site can create or allow the user of account 302 to create an album with the name #pbMikeBday or an album with another name or no particular name that is nonetheless associated with the hashtag #pbMikeBday or one or more other identifiers. Central site 301 can then facilitate collection of media elements associated with #pbMikeBday for storage in, for example, album 304d of account 302.

Central site 301, the user of account 302, or some other designated entity can control or specify the potential sources of media elements to be included in any search for media elements associated with the hashtag #pbMikeBday, for example. Central site 301 may establish a list of services or sites that will automatically be searched for media content (e.g., Facebook®, Twitter®, Instagram®, or other social media sites). In other embodiments, a user of account 302 can specify sites among an eligible list that should or should not be searched. Various other entities or methods may be used for determining the sources to be searched for content to be imported into a designated album 304d of the user's account 302.

Central site 301 can employ for example, a central API 350 or multiple APIs for searching (including to instruct hardware or other software elements to search) the central site 301 or one or more other sites 310, 330 for content associated with the hashtag #pbMikeBday. The central API or other software program may also be used to search one or more data feeds or “firehoses” from one or more sites or storage locations, which may or may not have been previously aggregated, filtered, or otherwise manipulated or processed. Central API 350 can, for example, directly search site 310, which can comprise, for example, Facebook®, for any media elements associated with hashtag #pbMikeBday. Searching can be done by crawling or otherwise automatically combing publicly accessible portions of the site or by accessing and searching a data feed of site 310 or portions of site 310, which may or may not be publicly accessible, through agreement with site 310 or other related service providers. For example, a central data feed (not shown) may be provided by an intermediate provider that aggregates one or more data feeds from one or more sites, and the central API 350 can search the central data feed (not shown) alone or in combination with searching other data feeds or other sites directly or indirectly. It is to be appreciated that central site 301 can, in addition to or instead of using its own central API 350, instruct a vendor or third party with access to another site or data feed from that site to search for and retrieve media elements associated with a target list of tags or other identifiers. Central site 301 can provide the vendor or third party necessary instructions or keys for posting the media elements and selected metadata to the appropriate album on central site 301, or the vendor can provide the media files and associated metadata to central site 301 for posting to the appropriate album. Accordingly, in some embodiments, trusted or authenticated third parties can directly push content from one or more sites or locations onto central site 301. The vendor or third party can also be the operator of the secondary site or location on which media elements are being posted, and the secondary site operator may agree to push media files (and associated data) matching hashtags or other identifiers on a target list to central site 301 for inclusion in the corresponding album or other location on central site 301.

In some embodiments, central API 350 can search for triggers comprising, for example, various hashtags, labels, or other identifiers that may be associated with media elements. Central site 301 can communicate to central API 350 the identifiers for which users of central site 301 would like to collect associated media elements. When a match is identified or triggered, the central API 350 can determine the location of any associated media elements and identify associated metadata. Central API 350 can then retrieve the targeted media elements and related metadata desired to be stored in association with the targeted media elements. One or more of the targeted media elements can then be posted at a designated location of central site 301 along with one or more metadata fields if desired. Alternatively, instead of posting a media element or one or more metadata fields to be visible on central site 301, a portion of it may be posted or a link to the original source may be posted.

As an example, in the embodiment depicted in FIG. 3, central site 301 can include the hashtag #pbMikeBday in a target list of identifiers desired to be collected on central site 301. Central API 350 can search a data feed for site 310 or a portion of site 310 for the hashtag #pbMikeBday. If picture 314, which may be a picture of Mike at his birthday party, has been posted on site 310 and associated with the hashtag #pbMikeBday, central API 350 will identify a match with an identifier in its target list. Central API 350 can then retrieve any or all media elements associated with the identified instance of the hashtag #pbMikeBday posted on site 310. Central API 350 can also review and retrieve any metadata it has been instructed or otherwise decides should be stored with the target media elements, such as picture 314. Desired metadata fields to retrieve and store with a media element, such as picture 314, can include the photographer, subject, source (e.g., site 310), date, time, location, file size, duration (e.g., of video), etc. Central API 350 can then provide, or central site 301 can retrieve, picture 314 and any retrieved metadata for posting on central site 301 in an album 304d associated with the hashtag #pbMikeBday.

In the embodiment of FIG. 3, picture 314 was posted by user account 312 of site 310. User account 312 can be controlled or associated with the same user that owns or controls account 302 of central site 301, for example, or can be a different person or other entity. The user of account 312 can be informed, directly or indirectly, by the user of account 302 that the hashtag #pbMikeBday has been registered with central site 301 for the purpose of collecting all media elements associated with Mike's Birthday in one album on central site 301. The user of account 312 need not be a registered user of central site 301 or do anything more than associate a media element uploaded to site 310 with the hashtag #pbMikeBday in order for such media elements to appear in album 304d of account 302 of central site 301. Central site 301 or account 302 can provide the user of account 312 access to one or more albums on central site 301, including album 304d associated with the hashtag #pbMikeBday.

When picture 314 is posted to or otherwise linked from album 304d, one or more metadata fields or portions thereof that have been retrieved may be posted along with it, including for the purpose of attributing the media element to its creator, original or intermediate source, or other identifying information. Associated metadata can also include any comments associated with the media element on one or more sites. Central API 350 can append additional metadata to picture 314, for example. Picture 314 can also have additional metadata or context appended to it by any one or more of central site 301, the user of account 302, or another user or other entity. Any of the retrieved or appended metadata fields or portion of them may be either stored in association with its corresponding media element, posted on central site 301 with the media element, or both.

In the embodiment depicted in FIG. 3, central API 350 can continue to search site 310 (including through one or more data feeds as discussed above) for additional instances of identifiers on its target list, for example the hashtag #pbMikeBday. Where a user of account 318 of site 310 has posted, for example, video 320 on site 310, central API 350 follows similar steps for retrieving video 320 and associated metadata as it did for retrieving picture 314 and associated metadata. The metadata associated with video 320 that is retrieved or posted on central site 301 can be the same or different than the metadata retrieved or posted for picture 314. Again, central site 301, the user of account 302 on central site 301, or other entity may designate the types of metadata to retrieve or post on central site 301, which may or may not take into account rules or preferences stated by administrators or users of the sites from which media elements are being gathered, e.g., site 310. Such rules could include, for example, that the source, e.g., account 312 of site 310 must be identified in any reposting of picture 314 or other media elements retrieved from site 310. Such attribution can be a requirement imposed by site 310, for example, in order to allow searching of the site 310 or a particular data feed from site 310.

As central API 350 searches site 310, it will identify matches with other identifiers in its target list, for example, the identifier #pbLandJWed. This will trigger central API 350 to follow the same steps in posting media elements associated with #pbLandJWed to central site 301, except that central site 301 or central API 350 can cause such media elements to be posted in a different location, e.g., album 308a of user account 306 on central site 301. User account 306 may have additional albums associated with its account, including, for example, albums 308b, 308c, 308d, and so on. In the embodiment depicted in FIG. 3, if account 312 has posted video 316 with a comment including #pbLandJWed and account 318 has posted picture 322 and tagged it with #pbLandJWed, video 316 and picture 322 will be posted to album 308a on central site 301 along with the desired metadata associated with these media elements.

In the embodiment depicted in FIG. 1, central API 350 can continue to search other sites, e.g., site 330, which can comprise, for example, Instagram® or Twitter®, for media elements with target identifiers #pbMikeBday, #pbLandJWed, or any other target identifiers on its target list. Account 332 on site 330 may have posted, for example, media element 334 associated with #pbMikeBday and image 336 associated with #pbLandJWed. System 300, through central API 350, can retrieve images 334 and 336 and post them to albums 304d and 308a, respectively, on central site 301. Similarly, account 338 on site 330 may have posted, for example, image 340 associated with #pbMikeBday and image 342 associated with #pbLandJWed. System 300, through central API 350, can retrieve images 340 and 342 and post them to albums 304d and 308a, respectively, on central site 301.

System 300 can also retrieve media elements from other sites (not shown) or locations, including a dedicated mailbox 360 for posting on the designated locations on central site 301. Mailbox 360 can include a permanent or temporary storage location for storing messages sent to one or more email addresses, phone numbers (including a short code number commonly used for text or other media messaging), or other communication tools. Mailbox 360 allows for central site 301 to create dedicated email addresses or phone numbers to which media elements or links to media elements may be sent. An email or text, for example, sent to mailbox 360 can contain, for example, a tag, hashtag, label, or other identifier specifying the location or locations on central site 301 where the media elements are desired to be posted or stored. A text may be in short message service (“SMS”) format, multimedia messaging service (“MMS”) format, or other messaging formats. There may, of course, be multiple mailboxes like mailbox 360, and each one can be associated with one or more email addresses, phone numbers, short code numbers, users of central site 301 or another site, other characteristics or criteria, or any combination of the foregoing. Mailbox 360 allows users to send media elements to central site 301 for inclusion within an album on central site 301 without or in addition to passing through a different site, e.g., sites 310, 330. If a user does not have an account with site 310, 330, or central site 301, or desires not to post a media element to site 310 or 330, or has posted a media element to a site that is not searched by system 300 or for other reasons excluded from an album on central site 301, the user can still send media elements for inclusion in a particular album on central site 301 by sending the media element, identifier, or other metadata or information to one or more email addresses or other receiving locations established by central site 301 or other third party. In some embodiments, central site 301 can establish a single, readily memorized email address or phone number for all users of central site 301 to distribute to others for sending media content to be included in an album on central site 301. In other embodiments, an individualized email address or phone number for text messages can be created to allow the user of central site 301 or the site itself to limit those sending media to mailbox 360 to those who know the email address or phone number.

As described in relation to the embodiment illustrated in FIG. 1, system 300 can allow users to push content to central site 301 or a designated location on central site 301. In some embodiments, system 300 can be considered a universal messaging system because it allows tags, labels, or other identifiers applied in one site to trigger sending of an associated media element to a location such as central site 301 that can allow access to multiple users, including those not registered with central site 301. System 300 can help avoid obstacles present in gathering photos taken by various attendees at an event such as a wedding, for example. Instead of being required to register for an account on a particular photo storage site, attendees can be informed of one or more hashtags or identifiers related to the event. Attendees can then post the media elements to any of the services searched by system 300 or send the media elements to a dedicated location, e.g., email address, phone number, or short code number, and the hashtag or other identifier associated with the media element will direct system 300 to store the media elements in the corresponding album on central site 301. The event organizer can register the hashtag or other identifier with central site 301 in advance of the event to ensure that no other user has already used the hashtag or other identifier. In some embodiments, the hashtag or other identifier can be registered during or after the event, or the identifier need not be registered at all in some embodiments and can be used by multiple users of central site 301. A potential advantage of some embodiments that collect media elements posted to another site such as Facebook® or Instagram® instead of collecting all photos, videos, etc. taken by all attendees and manually posted to a central location is that some filtering and selection can take place for posting on the original social media site such that a smaller selection of relevant media elements is included in the collection stored in the album on central site 301.

In some embodiments, central site 301, central API 350, or other hardware or software instructed to do so by system 300 can search one or more secondary sites (or one or more data feeds from one or more secondary sites) continuously and post media elements to central site 301 in real time as they are posted to a secondary site such as site 310. In other embodiments, secondary sites may be searched periodically, such as hourly, daily, weekly, etc., manually as requested by a user or site, or any combination of the above. The search for media elements on various sites or at various locations can also be structured to search for media elements posted during certain time periods, such as within the previous hour, day, week, or all available data can be searched retroactively, for example. In some embodiments, once an album is created on central site 301 to pull media elements with a specific hashtag or other identifier, only postings to secondary sites occurring after album creation are collected for storage and posting in the corresponding album on central site 301.

As has been explained, in addition to a hashtag, other identifiers may be used to trigger system 300 to retrieve and post media elements on central site 301. Any symbol or trigger, such as a text string, may be chosen to alert system 300 that a media element has been designated for posting to a specific album on central site 301. Central site 301 can control the distribution of unique identifiers to aid users in collecting only those media elements intended to be included in an album on central site 301. Central site 301 can include, for example, a signature within the tag, such as #pb that increases the likelihood that media elements tagged with the signature were intended to be sent to central site 301. In some embodiments, a signature within the tag can be a text string or other key that is unlikely to be used for a purpose other than to direct the media to the corresponding album on central site 301. Central site 301 can also, for example, not allow more than one user or account to use the same tag, label, or other identifier. In other embodiments, a user of central site 301 can also choose to create an album that will be populated by media elements associated with one or more tags, labels, or identifiers not controlled in any way by central site 301, and central site 301 can allow any number of users to create albums that will be populated by media elements associated with the same tags as other users or even multiple tags or identifiers. For example, rather than create an album with a tag specific to central site 301, e.g., with a signature such as “pb” in the hashtag, a user of central site 301 could provide a list of one or more hashtags related to any subject for which the user would like to collect media content in an album on the central site. The list of hashtags or other identifiers could include, for example #musclecars and any other related hashtags that may be likely to be associated with content related to that subject. In addition, the user of central site 301 can specify one or more keywords and system 300 can create a list of hashtags or other labels likely to be associated with the desired media content. Central site 301 can also create albums independent of any particular user, and the hashtags or subjects can be based on trending topics on a particular secondary site or across multiple sites. These albums can be made available to users of central site 301 or others based on criteria chosen by central site 301.

In addition to system 300 being able to search available sites and data feeds for all available media elements associated with one or more hashtags or other identifiers, central site 301 or a user of central site 301 that creates an album can specify certain filters or parameters to limit the number of media elements imported into central site 301. For example, the user of central site 301 can specify that only media elements posted by a list of specified users on the secondary sites should be imported into the album on central site 301. The user or central site 301 could also, for example, limit the size of the album on central site 301 where media elements are being collected, or the date range for collection, for example. Central site 301 or the user could also create a spam list of users or sources of media elements that should not be retrieved for collection on central site 301.

In some embodiments, system 300 can allow the user of account 302 on central site 301 to review content that has been retrieved prior to posting in the album corresponding to a hashtag, e.g., album 304d corresponding to hashtag #pbMikeBday. In other embodiments, however, it can be preferred that media elements are collected without any input from the user beyond providing the hashtag or other identifier desired to be collected.

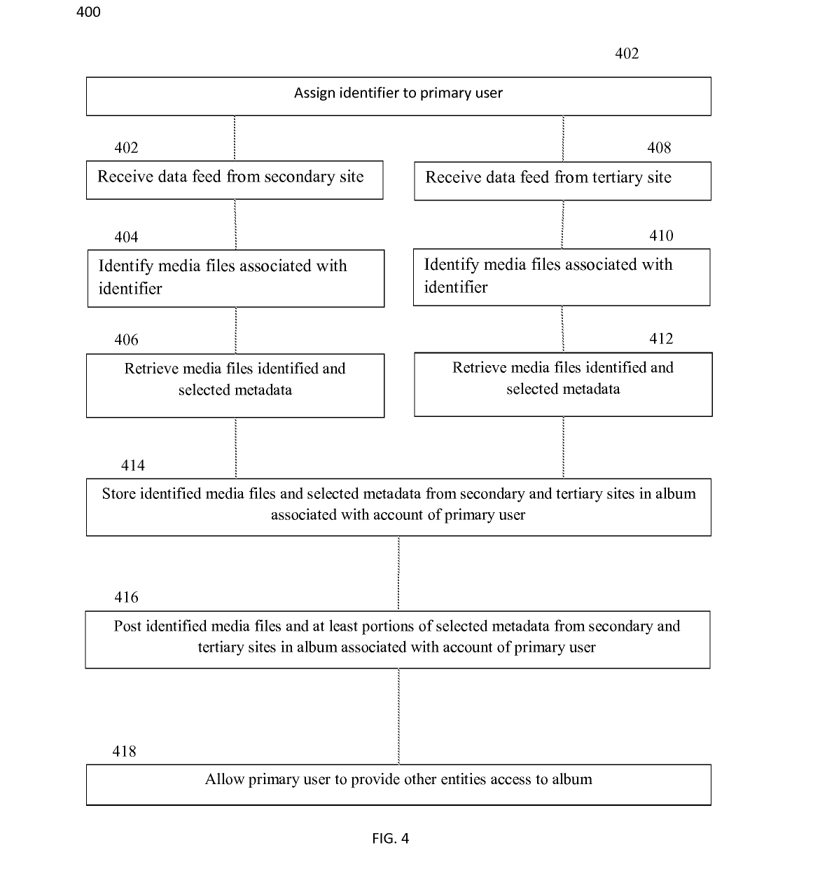

FIG. 4 illustrates an example method 400 for collecting media elements from other sites for storage or posting on a primary site. These actions may be performed by the operators of central site 301, for example, as depicted in FIG. 3, which may, but need not necessarily, be performed by or within the systems of FIG. 1 or FIG. 2. In one embodiment, the method 400 is fully performed by a single computing system while receiving input or direction from a separate computing system. As an example, the method 400 may be performed using a server component that communicates over a network with an end-user device. A user of the end-user device may provide input which the end-user device sends to the server component to assist the server component in performing the method 400 of FIG. 4. In other embodiments, however, user input or other instructions may be received at the same device performing the method 400, or the method 400 may be performed in a distributed manner by different devices or systems.

The method 400 may begin by assigning an identifier to a primary user (step 402). The identifier can be a hashtag or other identifier as described above in relation to FIG. 3. Data feeds are then received and reviewed from a secondary site and tertiary site in steps 402 and 408, respectively. These sites can be sites 310, 330 as depicted in FIG. 3. In step 404, media files in the secondary site that are associated with the assigned identifier are identified, and in step 406 the media files may be retrieved along with selected metadata associated with the media files. In steps 410-412, steps corresponding to steps 404 and 406 are performed on the data feed received from the tertiary site in order to identify additional media files from other sites and to retrieve them with selected metadata. In step 414, media files and metadata retrieved in steps 406 and 412 can be stored in an album associated with an account of the primary user. The account may be associated by the primary user with the identifier, as described above, and in particular with reference to FIG. 3. The media files and at least portions of metadata retrieved from the secondary and tertiary sites can also be posted to the album (step 416). The primary user can also control who may access the media files being collected and stored in the album (step 418).

Described above are systems and method for creating a collection of images, videos, and other elements. Throughout the description, for the purposes of explanation, numerous specific details are set forth in order to provide a thorough understanding of the present disclosure. It will be apparent, however, to one skilled in the art that the present disclosure may be practiced without some of these specific details, or that other details may be provided.

Embodiments of the present disclosure may generally be performed or implemented in one or more computing devices and systems, and more particularly performed in response to instructions provided by an application executed by the computing system. Embodiments of the present disclosure may thus comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures, including applications, tables, or other modules used to execute particular functions or direct selection or execution of other modules. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media. Computer-readable media including computer-executable instructions may also be referred to as a computer-program product.

Examples of computer storage media include RAM, ROM, EEPROM, CD-ROM or other optical disk storage, magnetic disk storage or other magnetic storage devices, solid state storage, or any other non-transmission medium which can be used to store desired program code means in the form of computer-executable instructions or data structures and which can be accessed by a general purpose or special purpose computer.

A “network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmissions media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, servers, and the like.

Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote volatile and/or nonvolatile storage devices.

Throughout the foregoing description, for the purposes of explanation, numerous specific details were set forth in order to provide a thorough understanding of the aspects of the disclosure, although embodiments may be practiced without some of these specific details. For example, it will be readily apparent to those of skill in the art that the functional modules may be implemented as software, hardware or any combination thereof. Accordingly, the scope and spirit of the present disclosure should be judged in terms of the claims which follow.

What is claimed is:

1. A system for presenting a plurality of media files identified as related by a plurality of users, comprising:
a program configured to review a first set of data received from a first media service and a second set of data received from a second media service, the program being configured to retrieve one or more media files identified by a unique identifier located within the first set of data and to retrieve one or more media files identified by the unique identifier located within the second set of data; and
a service account associated with a storage medium for storing and presenting the one or more media files identified by the unique identifier.

2. The system of claim 1, further comprising an email account configured to receive one or more messages containing the unique identifier and send one or more email media files identified by the one or more messages to the service account for storage on the storage medium.

3. The system of claim 1, further comprising a short messaging service (SMS) code provided to the plurality of users to allow the plurality of users to send an SMS message comprising the unique identifier to the service account for storing one or more SMS media files in the storage medium.

4. A system for gathering media messages, comprising:
a computer-readable storage medium associated with a service account; and
a program configured to identify a plurality of media messages addressed to the service account and to retrieve the plurality of media messages for storage in the computer-readable storage medium.

5. A method for collecting media files from a plurality of sources, comprising:
assigning a unique identifier to a primary user that controls an account with a primary media service;
receiving a plurality of media files from a secondary source that provides a secondary media service;
identifying a secondary set of one or more related media files associated with the unique identifier by a secondary user of the secondary media service;
receiving a plurality of media files from a tertiary source that provides a tertiary media service;
identifying a tertiary set of one or more related media files associated with the unique identifier by a user of the tertiary media service;
storing the secondary set of one or more related media files and the tertiary set of one or more related media files in a section of the account identified by the unique identifier; and
allowing the primary user of the primary media service to provide one or more of the secondary user and the tertiary user access to the section of the account identified by the unique identifier.
